(19) United States
(12) Patent Application Publication
(10) Pub. No.: US 2017/0039621 A1
(43) Pub. Date: Feb. 9, 2017

(54) Multi-Agent System for GPS Web Services

(71) Applicant: Glen Russell Harding, Ladera Ranch, CA (US)

(72) Inventor: Glen Russell Harding, Ladera Ranch, CA (US)

(21) Appl. No.: 14/818,299

(22) Filed: Aug. 4, 2015

(51) Int. Cl. G06Q 30/06; H04W 4/02; H04L 29/08

(52) U.S. Cl. CPC G06Q 30/0625; H04L 67/02; H04W 4/02

(57) ABSTRACT

The present invention is an internet communications system for connecting mobile Ecommerce consumers with registered mobile goods and services providers. Multi-Agent software is used for the web services Ecommerce platform and the invention uses the dynamic locations of mobile providers and consumers as the basis for matching them. The invention uses a center of the universe view wherein all available resource providers are seen updated in real-time relative to the current position of the consumer. In a demographic application, a contracted goods and services provider then converges to the current location of the customer.

### BACKGROUND OF THE INVENTION

The present invention comprises internet communications technology for connecting mobile customers with on-demand demographic goods and services providers. It is therefore related to internet and web services technology for Ecommerce. Moreover, in a preferred embodiment, Multi-Agent software technology is used for developing the web services Ecommerce platform. And furthermore, the invention uses the dynamic demographic locations of mobile providers and consumers as the basis for making Ecommerce proposals. Therefore, the invention is further related to location based Ecommerce and Geographic Information Systems (GIS) and Geographic Positioning Systems (GPS). The specific application developed is on-demand delivery of mobile demographic goods and services to the current location of a mobile consumer. The fundamental prior art for the current invention is “MAS for GPS Web Services”, Jul. 30, 2008, included as a disclosure with this application.

### SUMMARY OF THE INVENTION

An objective of the present invention is providing an internet web server for accepting global Ecommerce client connections. Moreover, it is a further objective to implement the Ecommerce platform using Multi-Agent software technology. And furthermore, it is an objective of the present invention to develop novel web services applications based on the dynamic locations of demographic goods and services providers and consumers.

The basis of the present invention is Geographic Positioning System (GPS) information and therefore requires devices, for example, that determine their location by circuit calculations or satellite systems. In one embodiment, the GPS information includes longitude, latitude, altitude, speed, heading, date, and time. This GPS information is sampled at a programmable frequency rate and the GPS data-gram is communicated to said web server by the mobile device using internet protocol.

A further objective is novel Ecommerce based on dynamic GPS information of demographic goods and services providers and consumers. In one embodiment, mobile demographic goods and services providers register with said web server and communicate their dynamically sampled GPS information when requested. A client connects to said web server and requests a web service and, in a preferred embodiment, also communicates dynamically sampled GPS information to said server. It is therein an objective of the present invention to make Ecommerce proposals based on the current GPS of a registered demographic goods and services provider and the current GPS of a demographic consumer.

The invention helps solve the problem of on-demand Ecommerce due to the fact that the dynamic locations of providers and consumers are matched by closest distance to each other. The client customer is offered a list of registered providers that match the customer web service request and are closest to the customer's current location. If the client contracts with one of the providers then the advertised goods and services are delivered to the current location of the mobile consumer. Advantages of the invention include on-demand convenience and timeliness for the consumer.

### DETAILED DESCRIPTION OF THE INVENTION

The present invention is built firstly using internet web server technology. In a preferred embodiment, Apache software is used for processing the infinite loop of incoming client connections. Moreover, in one web services Ecommerce model an individual web server corresponds to an individual category of demographic goods and services provider and is assigned a commercial domain name. In this model, a client using internet technology communicates the customer's current location and the web server returns the available dynamic goods and services providers sorted by closest distance to the current location of the customer. In a further embodiment, the web server maintains several categories of dynamic demographic goods and services providers. In this case, the client communicates the customer's current location together with a specific web services request. The web server searches its directory of registered providers and makes a list of those that match the customer's web services request before sorting the on-demand providers by closest distance to the consumer. In one Ecommerce model the client makes a selection of the available providers based on closest distance or cost, timeliness, luxury class, or other factors. In still another Ecommerce model, the goal GPS of the consumer is communicated to the closest providers and they compete for the customer's business. And in still a further embodiment, web server side logic is used to calculate the best fit and presented to the customer as a yes or no proposition. In each Ecommerce model, the goal of the web server is to match a dynamic producer with a dynamic consumer and make a contract for demographic goods and services for delivery to the current location of the customer. Hyper Text Transfer Protocol Secure (HTTPS) is used in a preferred embodiment for processing Ecommerce contracts and in general is used for customer authentication and secure communication of GPS location information.

In a preferred embodiment, the invention applies Multi-Agent technology for the web services platform. In general, this technology is particularly suited to the present invention due to the fact that it has web services Ecommerce constructs such as cyclic messaging behavior. Moreover, this technology is also well suited for delta time sampling and communication of GPS data-grams since looping behavior is inherent to the technology. Using this model, goods and services providers are dynamically registered and deregistered on the web server in a searchable directory. A dynamic resource provider's advertised web services is included in a directory entry and each individual goods and services provider has a unique Multi-Agent identifier for messaging. This unique multi-agent corresponds to the mobile internet device that an individual registered provider uses while active in the system. In general, when a client connects to the web server with a web service request, the directory is searched and a list of active providers that match the request is made. In particular, a client also communicates the customer's current location and the list of available matching providers is then sorted by closest distance to the customer. In a preferred embodiment, a relational database is used for sorting the list. Therefore, the present invention is particularly adapted to the internet platform for mobile devices that sample their GPS data-gram at a programmable frequency by circuit calculations or satellite systems.

In a preferred embodiment the present invention therefore comprises a web server for establishing global internet connections and communications, a Multi-Agent web services platform for handling Ecommerce connections and communications, and dynamic GPS data-grams of mobile suppliers and consumers for the inventive modeling step. In this model, the dynamic producers and consumers of the system interact based on relations such as, for example, closest geographic distance to each other. This inventive step is vital due to the fact that in an automated web server it performs the necessary step of pairing producers and consumers together based on novel location sorting. Therefore, the present invention enables broad Ecommerce applications wherein dynamic location sorting drives the automated web server. In a fully automated server, the closest distance, for example, is the basis for pairing a producer with a consumer. In a demographic application, for example, a consumer picks from a set of geographically closest goods and services providers to form the producer-consumer pair. A prototype web server is included with the online submission of this patent application showing proof of concept of the current invention.

An important contribution of the present invention for on-demand mobile Ecommerce is a center of the universe view based on the dynamic GPS data-grams of registered goods and services providers. In this geometric model, a fix-point is created wherein the current location of the customer is the center point. All available requested goods and services suppliers are seen relative to the customer's current center point. Moreover, the resources are seen updated at the GPS data-gram refresh rate of the mobile goods and services provider. Furthermore, in a preferred embodiment, a provider also uses a freeze-frame center of the universe view to see all the current goods and services demand relative to the current location of the provider as the center point. Furthermore, the present invention is platform neutral regarding mobile devices used in the system and therefore in principle the mobile device itself could be used for delivering on-demand goods to a consumer.

In general, the web server of the present invention is designed for coordinating and communicating with people using mobile internet devices. But in particular, the present invention focuses on the dynamic GPS data-gram of people in the system to enable on-demand Ecommerce. The present invention is designed as a web server and therefore Ecommerce applications are created using an internet address as the connection point. Therefore, an application is designed with a domain name and a model for how the multi-agents in the system interact based on their dynamic locations. As an example, if a group of people dynamically register under that web server as being available for social contact are providers in the system. A consumer person connecting to this site sees all the people available for social contact relative to the current location of the consumer person. The same Ecommerce principles apply for producer and consumer interaction regarding contract proposals and multi-agent conversations, but the application is unique due to how the multi-agents are modeled.

### BRIEF SUMMARY OF THE INVENTION

The current invention includes an internet web server for connecting mobile Ecommerce customers with registered demographic goods and services suppliers. Moreover, Multi-Agent technology is used to handle the Ecommerce web services connections and messaging. And importantly, the web server uses the dynamic locations of mobile providers and consumers as a basis for matching them. A center of the universe view is used wherein all available mobile service providers are updated in real-time relative to the customer's current location. A contracted goods and services provider then converges to the current location of the customer. Other customer connections means are available for those skilled in the art and Multi-Agent web services technology is used in a preferred implementation. The inventive step that can't be substituted is location sorting of the dynamic positions of consumers and producers to form Ecommerce contracts and continue processing the web server's continuous loop.

What is claimed is:

1. A communications system comprising an internet web server that handles incoming client web services connections in an infinite loop;
wherein said web server client connections are handled by independent process threads;
wherein said web server maintains a searchable directory system of registered goods and services providers represented as independent process threads;
wherein said client connection communicates to said web server location information selected from, but not limited to, current longitude, latitude, elevation, speed, heading, date, and time;
wherein said registered provider process threads communicate to said web server location information selected from, but not limited to, current longitude, latitude, elevation, speed, heading, date, and time;
wherein said web server sorts said registered goods and services providers by closest distance to the said client's current location;

2. The invention according to claim 1 wherein said client connections are handled using Multi-Agent software technology.

3. The invention according to claim 1 wherein said web server sorts using relational database technology.

4. The invention according to claim 1 wherein said web server selects the single closest distance registered goods and services provider for matching said client web services request;

5. The invention according to claim 1 wherein said web server communicates said sorted registered goods and services providers to said client for selection from as an Ecommerce proposition;

6. The invention according to claim 4 wherein said single closest registered goods and services provider is communicated to said client as a yes or no Ecommerce proposition;

7. The invention according to claim 5 wherein a geographic information systems map is drawn at the center of said client current location;

8. The invention according to claim 5 wherein the locations of said sorted registered goods and services providers are dynamically updated;

9. The invention according to claim 1 wherein said web server communicates calculated quantities to said client including, but not limited to, registered provider costs and time estimates;

10. The invention according to claim 1 wherein said web server communicates said registered provider's business information to said client for the purpose of informing said client in selecting a provider;

11. The invention according to claim 1 wherein upon successful execution of a web services contract between a client consumer and a registered goods and services provider, said provider converges to the current location of the client consumer to deliver the contracted goods and services;

12. The invention according to claim 1 wherein said client current location is given to more than one registered goods and services provider for the purpose of requesting competitive price quotes;

13. The invention according to claim 1 wherein said registered provider's current location is given to more than one client consumer for the purpose of requesting competitive price bids;

14. The invention according to claim 1 wherein goods and services requesting clients are sorted by closest distance to the current location of a registered goods and services provider;

15. The invention according to claim 1 wherein hyper text transfer protocol secure (HTTPS) is used for said internet communications.
